(19) United States
(12) Patent Application Publication
(10) Pub. No.: US 2025/0366608 A1
(43) Pub. Date: Dec. 4, 2025

(54) Folding Wardrobe

(71) Applicant: Taizhou Huangyan BIQIER Technology Co., LTD, Zhejiang Province (CN)

(72) Inventor: JUE ZHANG, Zhejiang Province (CN)

(21) Appl. No.: 19/024,856

(22) Filed: Jan. 16, 2025

(30) Foreign Application Priority Data
May 31, 2024 (CN) 2024212408063

(51) Int. Cl. A47B 61/00; A01M 29/12; A47B 43/00

(52) U.S. Cl. CPC A47B 61/00; A01M 29/12; A47B 43/00

(57) ABSTRACT

A folding wardrobe comprises a wardrobe body and a bottom plate. The wardrobe body comprises a first side plate, a second side plate, a third side plate and a fourth side plate; the bottom plate and the wardrobe body are rotatably connected; and a first door frame and a second door frame are arranged in the first side plate; a cover ring, arranged above the first side plate, the second side plate, the third side plate and the fourth side plate; a wardrobe body installing folding assembly, arranged in the first side plate and the second side plate and in the third side plate and the fourth side plate; and an installing assembly. In the utility model, by arranging the wardrobe body installing folding assembly, it is convenient for a user to install and fold the wardrobe body.

### TECHNICAL FIELD

The utility model relates to the technical field of wardrobes, and particularly relates to a folding wardrobe.

### BACKGROUND

The wardrobe is a cabinet for storing and placing clothing. It is usually made of stainless steel, solid wood, tempered glass and hardware fittings, and generally uses a wardrobe body, door plates, silent wheels and door curtains as assemblies. Clothing hanging rods, trousers racks, pull-out baskets, disinfection lamps and other fittings are arranged in the wardrobe. The wardrobe adopts the technologies of punching, assembly, pressing rivet, welding, etc., and has the effects of inflaming retarding, rat proofing, seamless cockroach prevention, dust prevention, moth proofing, moisture resistance, cleanness and beauty, and movement convenience. In daily life, a folding wardrobe is needed.

Most of the fittings in the folding wardrobe in the prior art are connected by hinging. If the fittings are damaged, there will be problems such as inconvenient replacement of the fittings, etc., which affects the normal use effect and maintenance effect of the folding wardrobe. Moreover, the height of the folding wardrobe in the prior art is fixed. If a higher wardrobe is made, the wardrobe is too long after being folded, which is inconvenient to package and transport the folded wardrobe.

By comparing with Chinese patent with the publication No. CN219895041U, the present application discloses a folding wardrobe which comprises a first support frame, a second support frame and a third support frame which are arranged vertically. A first folding mechanism is arranged between the first support frame and the second support frame. After the first folding mechanism is unfolded, a plurality of storing planes are formed. After the first folding mechanism is folded, the first support frame is close to the second support frame. A second folding mechanism is arranged between the second support frame and the third support frame. After the second folding mechanism is unfolded, support bottom plates are formed at the bottoms of the second support frame and the third support frame. After the second folding mechanism is folded, the third support frame is close to the second support frame. The folding wardrobe is easy to handle, and saves the assembly step. The bracket of the wardrobe is not only compact and stable in structure, but also folding, convenient to use, and good in overall performance.

The above solution can fold the entire wardrobe very conveniently, and the structure of the above solution is compact and stable, but the fittings used in the above solution are still connected by hinging. Moreover, the height of the wardrobe in the above solution is still fixed. The problems proposed in the above background are not solved.

Therefore, a folding wardrobe is provided by those skilled in the art to solve the problems proposed in the above background.

### SUMMARY

The utility model aims to provide a folding wardrobe, comprising a wardrobe body and a bottom plate, wherein the wardrobe body comprises a first side plate, a second side plate, a third side plate and a fourth side plate; the bottom plate and the wardrobe body are rotatably connected; and a first door frame and a second door frame are arranged in the first side plate;
a cover ring, arranged above the first side plate, the second side plate, the third side plate and the fourth side plate;
a wardrobe body installing folding assembly, arranged in the first side plate and the second side plate and in the third side plate and the fourth side plate, used for installing the entire wardrobe body and capable of facilitating a user to fold the entire wardrobe body;
an installing assembly, arranged in the first door frame and the second door frame respectively and used for installing a wardrobe door.

As the further improvement of the technical solution, the bottom of the cover ring is provided with a ring bayonet; upper surfaces of the first side plate, the second side plate, the third side plate and the fourth side plate are provided with side plate grooves for the ring bayonet to move; an upper cover is arranged above the cover ring; and the bottom of the upper cover is fixedly connected with a hanging device.

As the further improvement of the technical solution, the wardrobe body installing folding assembly comprises a plurality of side plate pin seats arranged on both sides of the first side plate and the second side plate; both sides of the third side plate and the fourth side plate are provided with a plurality of side plate bolts; the plurality of side plate pin seats and the side plate bolts are matched and installed; the third side plate and the fourth side plate have the same structure; and side plate bending grooves are arranged in the third side plate and the fourth side plate.

As the further improvement of the technical solution, the installing assembly comprises double-head rotating shaft seats arranged in the first door frame and the second door frame respectively; upper surfaces and lower surfaces of the double-head rotating shaft seats are provided with rotating shaft columns; bayonet parts are arranged outside the double-head rotating shaft seats; and inner side walls of the first door frame and the second door frame are provided with clamping grooves for clamping the bayonet parts.

As the further improvement of the technical solution, the installing assembly comprises a single-head rotating shaft seat arranged in the second door frame; a surface of the single-head rotating shaft seat is provided with a rotating shaft column; a bayonet part is arranged outside the single-head rotating shaft seat; and the inner side wall of the second door frame is provided with a clamping groove for clamping the bayonet part.

As the further improvement of the technical solution, a baffle plate, a first layer plate and a second layer plate are arranged in the wardrobe body respectively; the first layer plate is clamped between the third side plate and the baffle plate; the second layer plate is arranged between the fourth side plate and the baffle plate; both ends of the baffle plate are provided with baffle rotating shafts; a surface of a rear end of the first side plate is symmetrically provided with side plate through holes; the baffle rotating shafts and the side plate through holes are matched and installed; a plurality of limiting blocks are arranged in the second side plate; a plurality of layer bumps are arranged outside the first layer plate; a baffle through hole for the layer bumps to move is arranged in the baffle plate; the bottom of the baffle through hole is provided with a baffle clamping hook; a movable groove for the baffle clamping hook to move is arranged outside the first layer plate; both sides of the first side plate are provided with a plurality of supporting blocks; a plurality of side plate bumps are arranged in the second side plate; both sides of the second side plate are provided with a plurality of side plate positioning buckles; a plurality of layer rotating shafts are arranged outside the second layer plate; and baffle rotating shaft seats matched with the layer rotating shafts are arranged outside the baffle plate.

As the further improvement of the technical solution, the bottom of the second side plate is provided with a plurality of side plate rotating shaft seats; the bottom plate comprises a first bottom plate and a second bottom plate; bottom rotating shafts matched with the side plate rotating shaft seats are arranged outside the first bottom plate and the second bottom plate; the bottom of the first side plate is provided with a plurality of inserting ports; and bottom inserting heads matched with the inserting ports are arranged outside the first bottom plate and the second bottom plate.

As the further improvement of the technical solution, the folding wardrobe further comprises a folding drawer which is movably connected with the wardrobe body through a track; both sides of the drawer are hung on the track; both ends of the track are provided with track convex buckles; a plurality of side plate positioning grooves are arranged in the first side plate and the second side plate; the plurality of track convex buckles are clamped in the side plate positioning grooves; and an upper surface of the drawer is provided with a track lock catch.

As the further improvement of the technical solution, the inner wall of the first side plate or the second side plate is clamped with a light groove; the outer side of the light groove is symmetrically provided with side plate clamping buckles; a light belt is arranged in the light groove; and the light groove is made of aluminum alloy material.

As the further improvement of the technical solution, the folding wardrobe further comprises protective sleeves; the bottom of the wardrobe body is symmetrically provided with reinforcing strips; a side plate installing groove is arranged outside the second side plate; and the upper surface of the bottom plate is provided with an aromatherapy box.

Compared with the prior art, the utility model has the beneficial effects:
1. In the folding wardrobe, through the arranged wardrobe body installing folding assembly and the installing assembly, when the entire wardrobe body needs to be installed, the first side plate, the second side plate, the third side plate and the fourth side plate can be conveniently installed rotatably only through the wardrobe body installing folding assembly, so as to achieve the purpose of assembling the entire wardrobe body. After the installation is completed, there is no need to install the wardrobe body again in subsequent use and folding. Meanwhile, through the wardrobe body installing folding assembly, it is also convenient for the user to fold the entire wardrobe body. The wardrobe can be opened at one time, which eliminates a hinging shaft and a rotating joint. Rotatable connection is achieved through the own structure. The structure is simple and reliable.
2. When the wardrobe door needs to be installed, the wardrobe door can be conveniently installed in the first door frame and the second door frame only through the installing shafts of the installing assembly and the wardrobe door. Meanwhile, it is convenient for the user to replace the damaged wardrobe door and installing assembly, which improves the overall practicality of the wardrobe. When only the wardrobe door is installed, the installing assembly adopts the double-head rotating shaft seats, which is convenient for the installation of a single wardrobe door or double wardrobe doors. When the combination of the wardrobe door and the drawer is installed, the installing assembly adopts the single-head rotating shaft seat, which is convenient for ensuring the smooth opening and closing of the wardrobe door, without affecting the pulling of the drawer.
   When only the drawer is installed, the installing assembly can be removed, so as to achieve multiple combinations of the wardrobe door and the drawer, and improve the versatility of the wardrobe.
3. The track of the drawer of the wardrobe is installed by clamping, which is convenient for the user to disassemble the folding wardrobe and is also convenient for the user to replace the damaged drawer. Through the installed light groove, side plate clamping buckles and light belt, it is convenient for the user to install the light belt, thereby improving the versatility of the wardrobe, and then effectively improving the actual use experience of the user.

### DESCRIPTION OF DRAWINGS

FIG. 1 is an integral three-dimensional structural schematic diagram 1 of the utility model;

FIG. 2 is an integral three-dimensional structural schematic diagram 2 of the utility model;

FIG. 3 is an integral three-dimensional structural schematic diagram 3 of the utility model;

FIG. 4 is an integral three-dimensional structural schematic diagram 4 of the utility model;

FIG. 5 is a split three-dimensional structural schematic diagram of a cover ring in the utility model;

FIG. 6 is a bottom three-dimensional structural schematic diagram of the utility model;

FIG. 7 is a three-dimensional structural schematic diagram of a layer plate structure in the utility model;

FIG. 8 is a split three-dimensional structural schematic diagram of an upper cover in the utility model;

FIG. 9 is an amplified structural schematic diagram of region A in FIG. 7;

FIG. 10 is a top three-dimensional structural schematic diagram after folding of the utility model;

FIG. 11 is a three-dimensional structural schematic diagram of an inserting port structure in the utility model;

FIG. 12 is a three-dimensional structural schematic diagram of a bottom plate structure in the utility model;

FIG. 13 is a three-dimensional structural schematic diagram of a wardrobe body structure in the utility model;

FIG. 14 is a three-dimensional structural schematic diagram of a baffle plate structure in the utility model;

FIG. 15 is a three-dimensional structural schematic diagram of a drawer structure in the utility model;

FIG. 16 is a three-dimensional structural schematic diagram of a track structure in the utility model;

FIG. 17 is a three-dimensional structural schematic diagram of a cover ring structure in the utility model;

FIG. 18 is a three-dimensional structural schematic diagram of a double-head rotating shaft seat and a single-head rotating shaft seat in the utility model;

FIG. 19 is a three-dimensional structural schematic diagram of a third side plate in the utility model.

### MEANINGS OF NUMERALS IN THE DRAWINGS

1 wardrobe body; 2 upper cover; 3 wardrobe door; 4 double-head rotating shaft seat; 5 single-head rotating shaft seat; 6 drawer; 7 hanging device; 8 cover ring; 9 first door frame; 10 second door frame; 11 baffle plate; 12 baffle clamping hook; 13 first layer plate; 14 second layer plate; 15 reinforcing strip; 16 bottom plate; 161 first bottom plate; 162 second bottom plate; 17 first side plate; 18 second side plate; 19 third side plate; 20 fourth side plate; 21 baffle rotating shaft seat; 22 layer rotating shaft; 23 layer bump; 24 baffle through hole; 25 supporting block; 26 side plate groove; 27 side plate clamping buckle; 28 light groove; 29 light belt; 30 side plate bump; 31 side plate positioning buckle; 32 bottom rotating shaft; 33 aromatherapy box; 34 side plate rotating shaft seat; 35 baffle rotating shaft; 36 side plate through hole; 37 inserting port; 38 bottom inserting head; 40 side plate pin seat; 41 side plate bolt; 42 limiting block; 43 track convex buckle; 44 side plate positioning groove; 45 track lock catch; 46 track; 47 side plate installing groove; 48 ring bayonet; 50 bayonet part; 51 rotating shaft column; 53 side plate bending groove; 54 protective sleeve.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

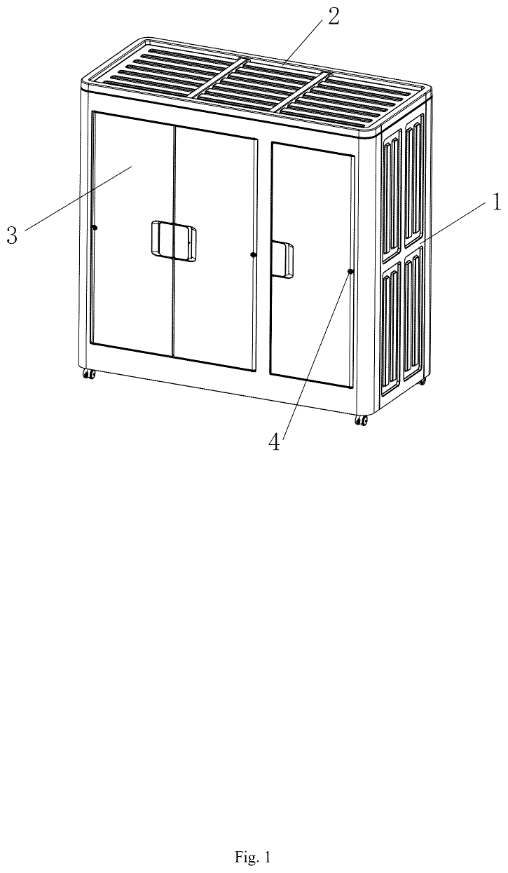

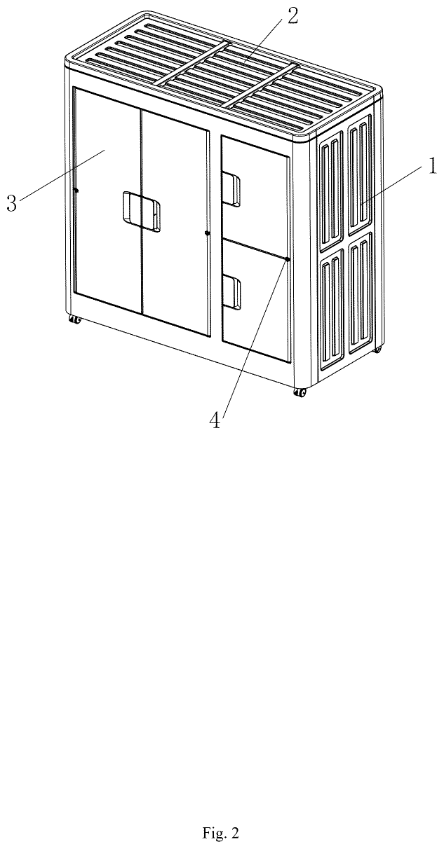

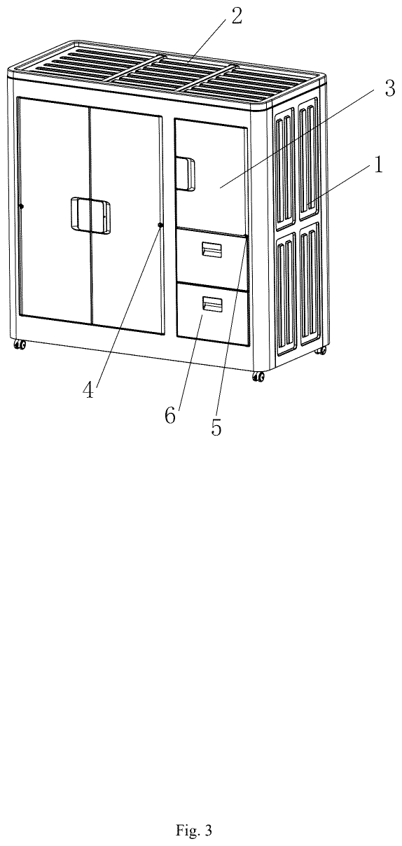

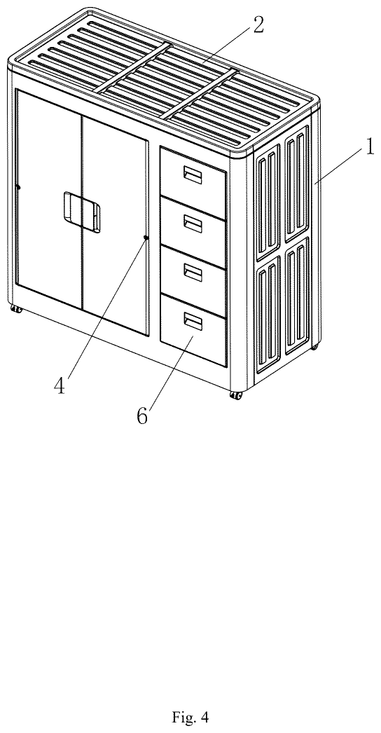

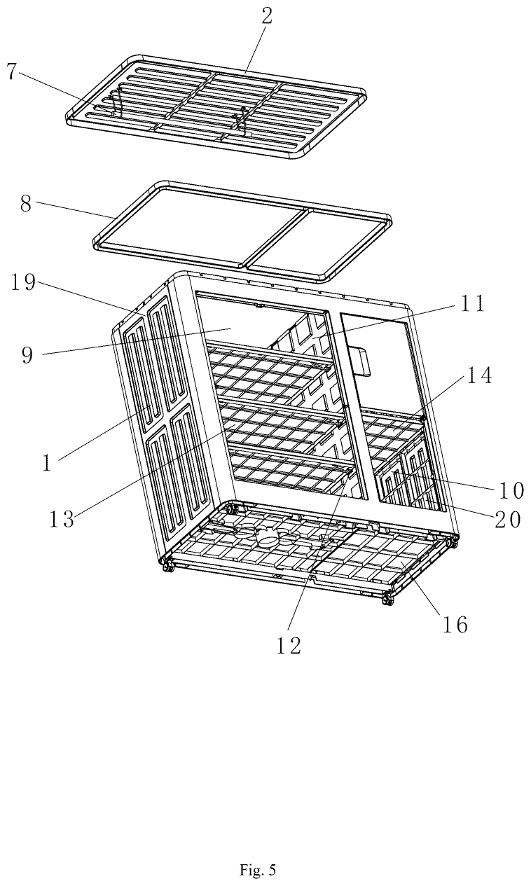

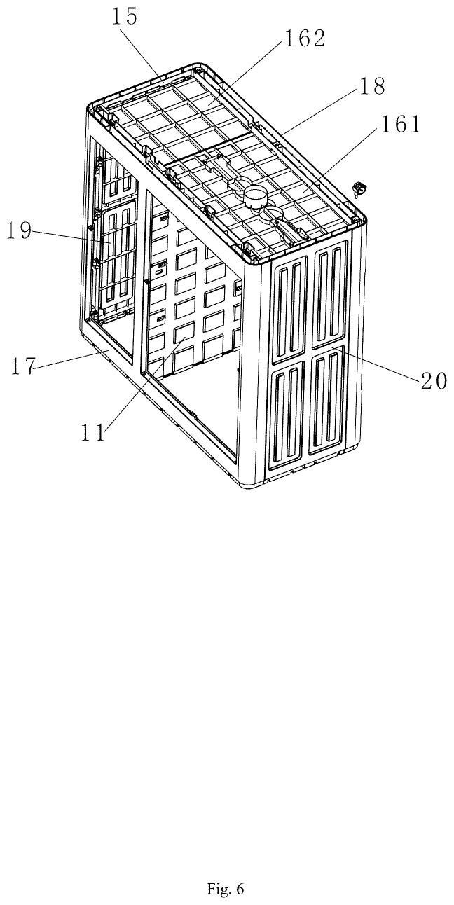

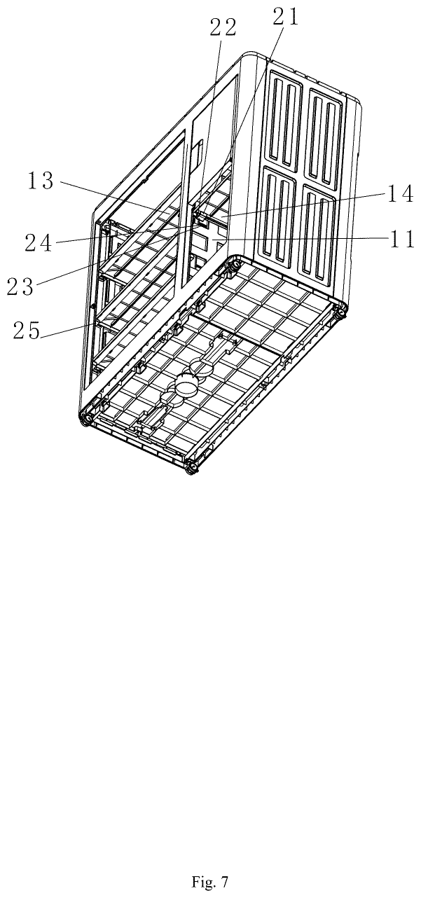

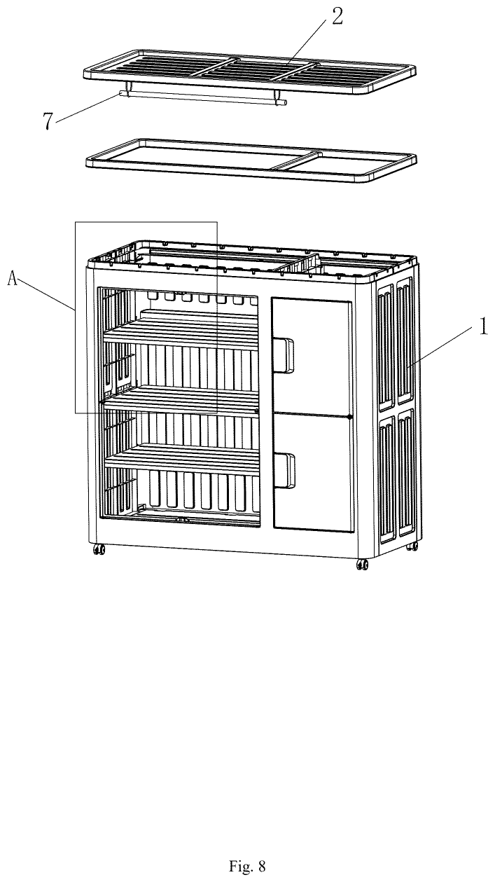

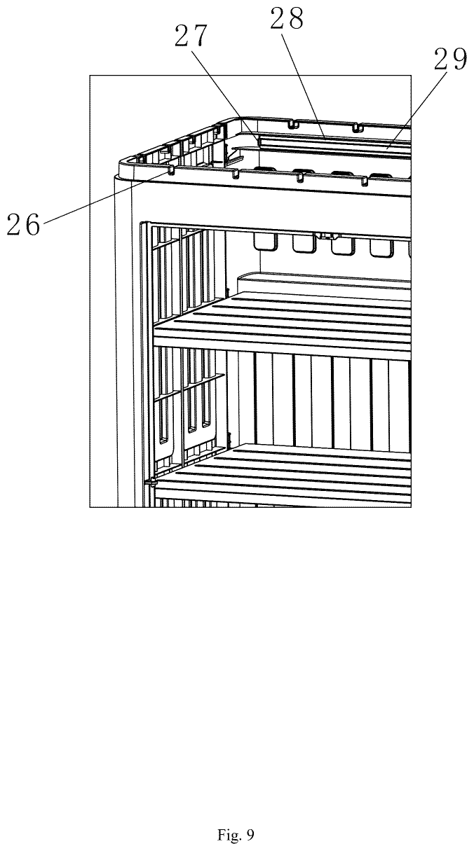

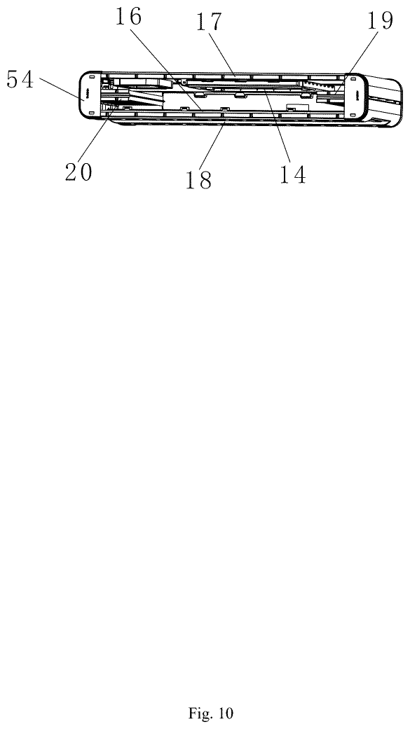

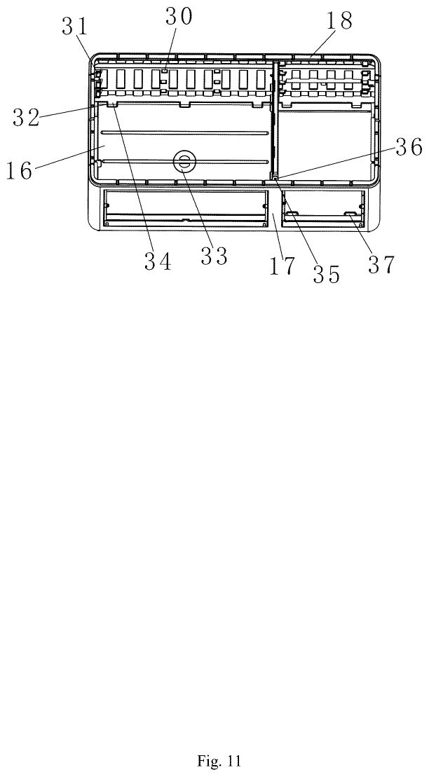

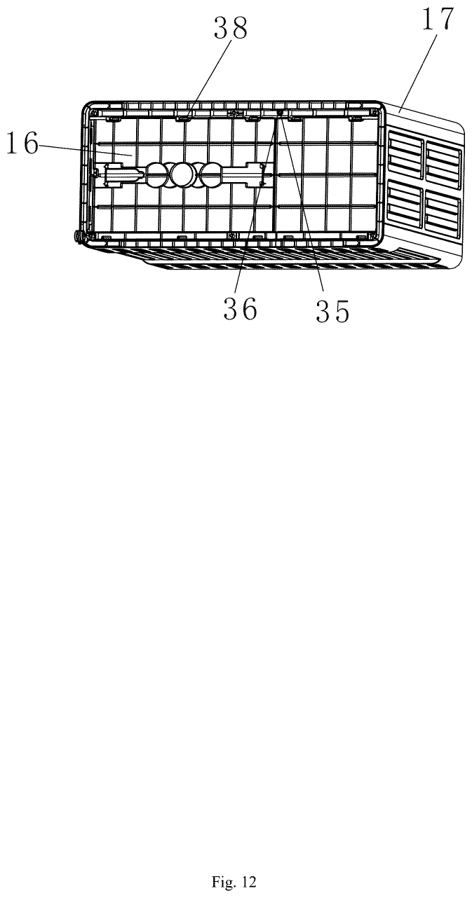

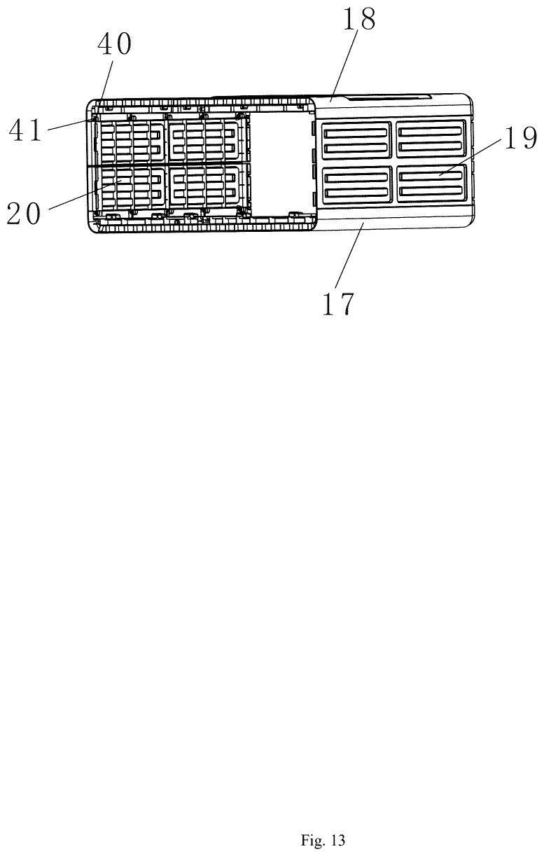

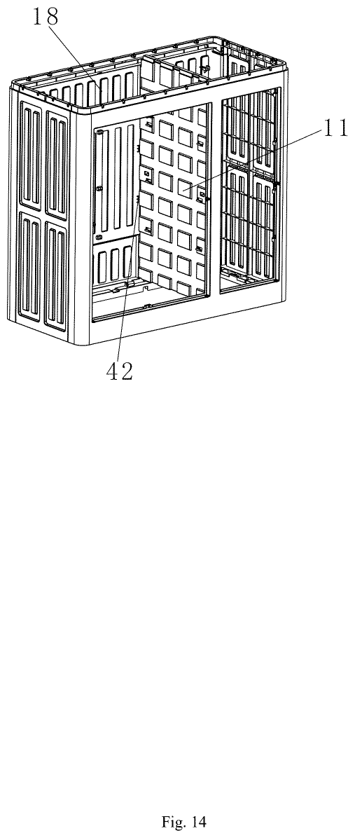

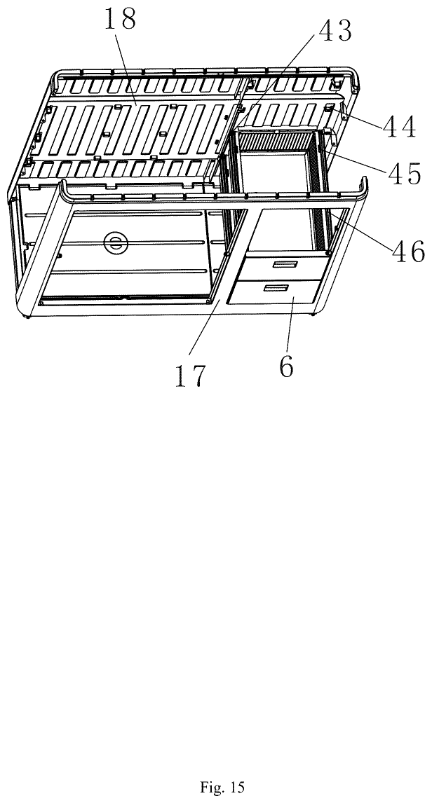

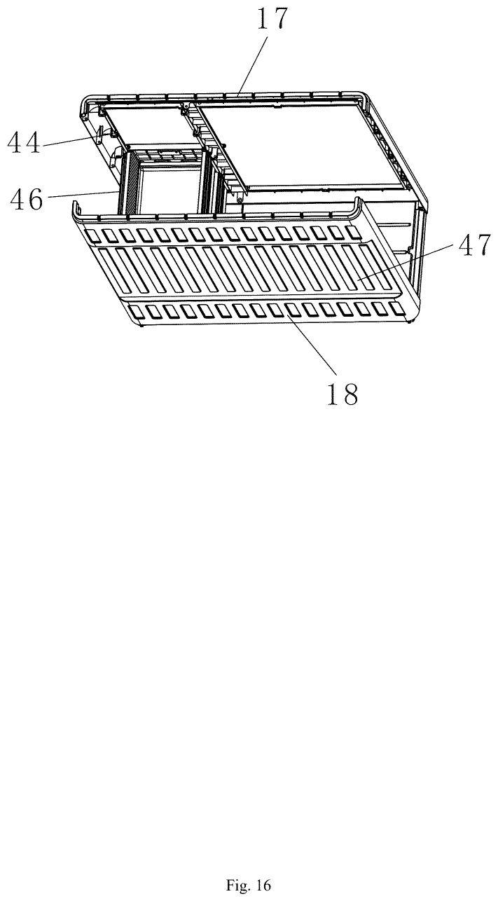

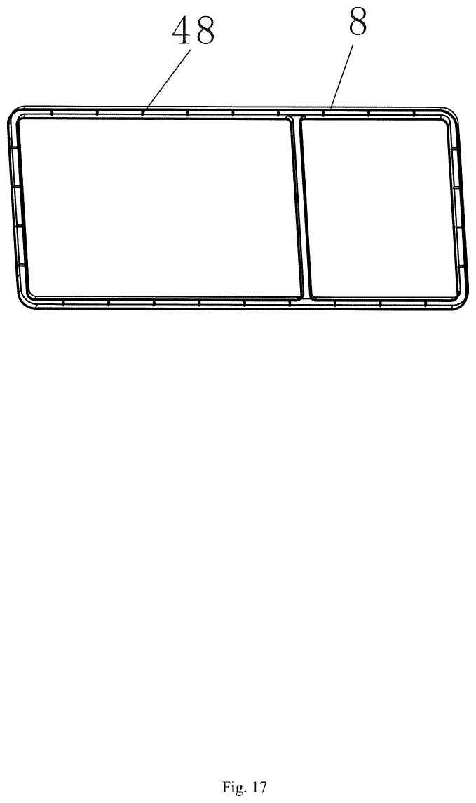

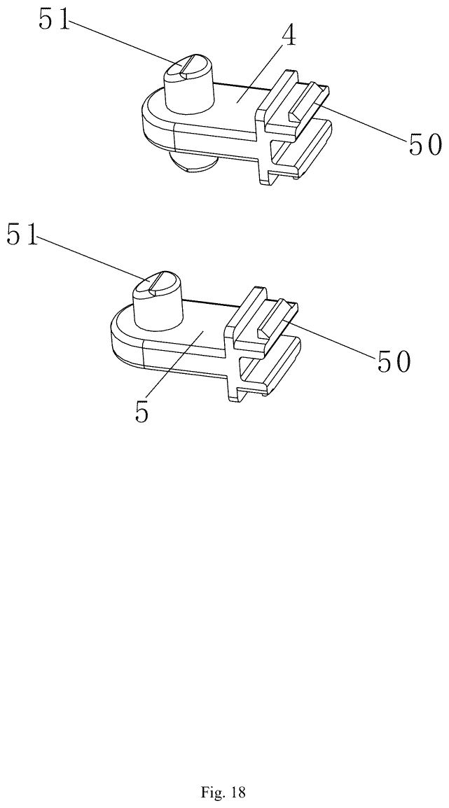

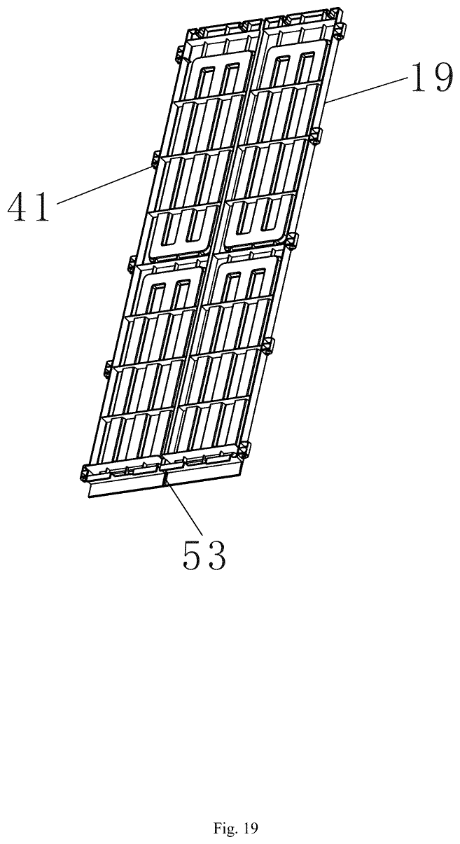

As shown in FIG. 1 to FIG. 19, the present embodiment provides a folding wardrobe, comprising a wardrobe body 1 and a bottom plate 16; the wardrobe body 1 comprises a first side plate 17, a second side plate 18, a third side plate 19 and a fourth side plate 20; the bottom plate 16 and the wardrobe body 1 are rotatably connected; and a first door frame 9 and a second door frame 10 are arranged in the first side plate 17;
a cover ring 8, arranged above the first side plate 17, the second side plate 18, the third side plate 19 and the fourth side plate 20;
a wardrobe body installing folding assembly, arranged in the first side plate 17 and the second side plate 18 and in the third side plate 19 and the fourth side plate 20, used for installing the entire wardrobe body 1 and capable of facilitating a user to fold the entire wardrobe body 1;
an installing assembly, arranged in the first door frame 9 and the second door frame 10 respectively and used for installing a wardrobe door 3.

The above working principle is: When the entire wardrobe body 1 needs to be installed, the first side plate 17, the second side plate 18, the third side plate 19 and the fourth side plate 20 can be conveniently installed rotatably only through the wardrobe body installing folding assembly, so as to achieve the purpose of assembling the entire wardrobe body 1. After the installation is completed, there is no need to install the wardrobe body again in subsequent use and folding. Meanwhile, through the wardrobe body installing folding assembly, it is also convenient for the user to fold the entire wardrobe body 1. The wardrobe can be opened at one time, which eliminates a hinging shaft and a rotating joint. Rotatable connection is achieved through the own structure. The structure is simple and reliable. When the wardrobe door 3 needs to be installed, the wardrobe door 3 can be conveniently installed in the first door frame 9 and the second door frame 10 only through the installing shafts of the installing assembly and the wardrobe door 3. Meanwhile, it is convenient for the user to replace the damaged wardrobe door 3 and installing assembly, which improves the overall practicality of the wardrobe.

To effectively improve the overall strength of the wardrobe body 1 after installation, the bottom of the cover ring 8 is provided with a ring bayonet 48; upper surfaces of the first side plate 17, the second side plate 18, the third side plate 19 and the fourth side plate 20 are provided with side plate grooves 26 for the ring bayonet 48 to move; an upper cover 2 is arranged above the cover ring 8; and the bottom of the upper cover 2 is fixedly connected with a hanging device 7. When the first side plate 17, the second side plate 18, the third side plate 19 and the fourth side plate 20 are installed, the cover ring 8 is covered on the upper surfaces of the first side plate 17, the second side plate 18, the third side plate 19 and the fourth side plate 20. At this time, the ring bayonet 48 is inserted into the side plate grooves 26 on the upper surfaces of the first side plate 17, the second side plate 18, the third side plate 19 and the fourth side plate 20, which can make the installation of the cover ring 8 more firm, and thus can effectively improve the overall strength of the wardrobe body 1. Through the arrangement of the hanging device 7, the hanging device 7 comprises a hanging rod, which can allow a user to hang the clothing on the hanging rod, thereby enhancing the practicality of the wardrobe body 1.

Considering that the wardrobe body 1 needs to be installed at first when the wardrobe body 1 is used, the wardrobe body installing folding assembly comprises a plurality of side plate pin seats 40 arranged on both sides of the first side plate 17 and the second side plate 18; both sides of the third side plate 19 and the fourth side plate 20 are provided with a plurality of side plate bolts 41; the plurality of side plate pin seats 40 and the side plate bolts 41 are matched and installed; the third side plate 19 and the fourth side plate 20 have the same structure; and side plate bending grooves 53 are arranged in the third side plate 19 and the fourth side plate 20. When the wardrobe body 1 needs to be installed, only the side plate bolts 41 and the side plate pin seats 40 need to be installed. After the side plate bolts 41 and the side plate pin seats 40 are installed, the first side plate 17, the second side plate 18, the third side plate 19 and the fourth side plate 20 can be rotatably connected pairwise. Through the side plate bolts 41 and the side plate pin seats 40 which are formed integrally, the rotatable connection can be realized through a simple structure, which eliminates the troublesome installation and unnecessary rotating joints, and effectively improves the installation efficiency of the wardrobe body 1. When the wardrobe body 1 needs to be folded, the side plate bending grooves 53 need to be folded into the wardrobe body 1 only. The arrangement of the side plate bending grooves 53 enables the third side plate 19 and the fourth side plate 20 to be folded, so that the wardrobe body 1 can be folded. By installing the third side plate 19 and the fourth side plate 20 of the same structure, a set of molds is saved, which saves the processing cost.

To install the wardrobe door 3 conveniently, the installing assembly comprises double-head rotating shaft seats 4 arranged in the first door frame 9 and the second door frame 10 respectively; upper surfaces and lower surfaces of the double-head rotating shaft seats 4 are provided with rotating shaft columns 51; bayonet parts 50 are arranged outside the double-head rotating shaft seats 4; and inner side walls of the first door frame 9 and the second door frame 10 are provided with clamping grooves for clamping the bayonet parts 50. When the wardrobe door 3 needs to be installed, the bayonet part 50 only needs to be clamped into the clamping groove on the inner side wall of the first door frame 9 or the second door frame 10 at first, and then the double-head rotating shaft seats 4 can be fixedly installed, so that the wardrobe door 3 can be conveniently installed. The double-head rotating shaft seats 4 are used to ensure the smooth opening and closing of a single wardrobe door 3 or double wardrobe doors 3.

To combine and install the wardrobe door 3 and the drawer 6 conveniently, the installing assembly comprises a single-head rotating shaft seat 5 arranged in the second door frame 10; a surface of the single-head rotating shaft seat 5 is provided with a rotating shaft column 51; a bayonet part 50 is arranged outside the single-head rotating shaft seat 5; and the inner side wall of the second door frame 10 is provided with a clamping groove for clamping the bayonet part 50. When the combination of the wardrobe door 3 and the drawer 6 needs to be installed in the second door frame 10, only the single-head rotating shaft seat 5 needs to be fixedly installed on the inner side wall of the second door frame 10. At this time, only the bayonet part 50 outside the single-head rotating shaft seat 5 needs to be clamped into the clamping groove in the inner side wall of the second door frame 10, and the single-head rotating shaft seat 5 can be fixedly installed. Thus, the user can fixedly install the combination of the wardrobe door 3 and the drawer 6. The single-head rotating shaft seat 5 is used to ensure the smooth opening and closing of the wardrobe door 3, but may not affect the pulling of the drawer 6. When only the drawer 6 is installed, the installing assembly can be removed, so as to achieve multiple combinations of the wardrobe door 3 and the drawer 6, and improve the versatility of the wardrobe.

To ensure the installation stability of the wardrobe door 3, the double-head rotating shaft seats 4 and the first door frame 9 can be formed integrally.

To install the baffle plate 11, the first layer plate 13 and the second layer plate 14 conveniently, the baffle plate 11, the first layer plate 13 and the second layer plate 14 are arranged in the wardrobe body 1 respectively; the first layer plate 13 is clamped between the third side plate 19 and the baffle plate 11; the second layer plate 14 is arranged between the fourth side plate 20 and the baffle plate 11; both ends of the baffle plate 11 are provided with baffle rotating shafts 35; a surface of a rear end of the first side plate 17 is symmetrically provided with side plate through holes 36; the baffle rotating shafts 35 and the side plate through holes 36 are matched and installed; a plurality of limiting blocks 42 are arranged in the second side plate 18; a plurality of layer bumps 23 are arranged outside the first layer plate 13; a baffle through hole 24 for the layer bumps 23 to move is arranged in the baffle plate 11; the bottom of the baffle through hole 24 is provided with a baffle clamping hook 12; a movable groove for the baffle clamping hook 12 to move is arranged outside the first layer plate 13; both sides of the first side plate 17 are provided with a plurality of supporting blocks 25; a plurality of side plate bumps 30 are arranged in the second side plate 18; both sides of the second side plate 18 are provided with a plurality of side plate positioning buckles 31; a plurality of layer rotating shafts 22 are arranged outside the second layer plate 14; and baffle rotating shaft seats 21 matched with the layer rotating shafts 22 are arranged outside the baffle plate 11. When the baffle plate 11 needs to be installed, the baffle rotating shafts 35 need to be installed in the side plate through holes 36 only at first, and then the baffle plate 11 and the first side plate 17 can be rotatably connected. Through the arrangement of the limiting block 42, the opened baffle plate 11 can be effectively limited, so that the user can fold the baffle plate 11 by applying a certain external force when needing to fold the baffle plate 11. When the first layer plate 13 needs to be installed, the first layer plate 13 only needs to be erected above the side plate bumps 30, and supporting blocks 25 and the side plate positioning buckles 31 are clamped into the bottom of the first layer plate 13. At this moment, the first layer plate 13 can be fixedly installed. When the second layer plate 14 needs to be installed, the layer rotating shafts 22 and the baffle rotating shaft seats 21 only need to be installed at first, and then the second layer plate 14 and the baffle plate 11 can be rotatably connected; the second layer plate 14 is erected above the side plate bumps 30; and the supporting blocks 25 and the side plate positioning buckles 31 are clamped into the bottom of the second layer plate 14. At this moment, the second layer plate 14 can be fixedly installed.

In addition, to effectively install the bottom plate 16, the bottom of the second side plate 18 is provided with a plurality of side plate rotating shaft seats 34; the bottom plate 16 comprises a first bottom plate 161 and a second bottom plate 162; bottom rotating shafts 32 matched with the side plate rotating shaft seats 34 are arranged outside the first bottom plate 161 and the second bottom plate 162; the bottom of the first side plate 17 is provided with a plurality of inserting ports 37; and bottom inserting heads 38 matched with the inserting ports 37 are arranged outside the first bottom plate 161 and the second bottom plate 162. When the bottom plate 16 needs to be installed, only the bottom rotating shafts 32 and the side plate rotating shaft seats 34 need to be installed at first, then the second side plate 18 can be rotatably connected with the first bottom plate 161 and the second bottom plate 162 respectively, and the bottom inserting heads 38 and the inserting ports 37 can be installed. At this moment, the first bottom plate 161 and the second bottom plate 162 can be inserted and installed with the first side plate 17 respectively, so that the bottom plate 16 can be installed. After the installation is completed, the first bottom plate 161 and the second bottom plate 162 are installed on both sides of the baffle plate 11 respectively and correspond to the positions of the first door frame 9 and the second door frame 10.

To enhance the storage function of the wardrobe, the wardrobe further comprises a folding drawer 6 which is movably connected with the wardrobe body 1 through a track 46; both sides of the drawer 6 are hung on the track 46; both ends of the track 46 are provided with track convex buckles 43; a plurality of side plate positioning grooves 44 are arranged in the first side plate 17 and the second side plate 18; the plurality of track convex buckles 43 are clamped in the side plate positioning grooves 44; and an upper surface of the drawer 6 is provided with a track lock catch 45. The track 46 of the drawer 6 of the wardrobe is installed by clamping, which is convenient for the user to disassemble the folding wardrobe and is also convenient for the user to replace the damaged drawer 6. Because the drawer 6 can be folded, after the wardrobe is folded, the drawer 6 can be folded together, which is convenient for packaging and transportation.

To improve the versatility of the wardrobe, the inner wall of the first side plate 17 or the second side plate 18 is clamped with a light groove 28; side plate clamping buckles 27 are symmetrically arranged in the light groove 28; a light belt 29 is arranged in the light groove 28; and the light groove 28 is made of aluminum alloy material. Through the installed light groove 28, side plate clamping buckles 27 and light belt 29, it is convenient for the user to install the light belt 29, thereby improving the versatility of the wardrobe, and then effectively improving the actual use experience of the user. The aluminum alloy light groove 28 is arranged for supporting the wardrobe body 1, which enhances the stability of the wardrobe.

To maintain the state of the wardrobe after being folded to prevent the wardrobe from scattering, the wardrobe further comprises protective sleeves 54; the protective sleeves 54 are sleeved at four corners of the folded wardrobe body 1 and used for protecting the wardrobe from bumping and maintaining the folding state of the wardrobe to prevent the wardrobe from scattering during handling and transportation.

To improve the strength of the wardrobe body 1 after being unfolded to prevent the deformation of the wardrobe body 1 after being unfolded, the bottom of the wardrobe body 1 is symmetrically provided with reinforcing strips 15, and the reinforcing strips 15 are used for reinforcing the bottom of the wardrobe body 1 after being unfolded so that the wardrobe body 1 is more firm and not easy to deform after being unfolded.

To facilitate the packaging and transportation of the wardrobe body 1, a side plate installing groove 47 is arranged outside the second side plate 18. When the wardrobe body 1 is folded, the upper cover 2 and the cover ring 8 are stored in the side plate installing groove 47, thereby effectively saving storage space and facilitating packaging and transportation of the wardrobe body 1.

To further enhance the practicability of the wardrobe body 1, the upper surface of the bottom plate 16 is provided with an aromatherapy box 33. The user can place objects such as incense or mothballs in the aromatherapy box 33 to achieve the purpose of incense treatment of the clothing or insect repelling treatment of the interior of the wardrobe body 1.

For facilitate the hanging of long clothing, the upper cover 2 can be removed, the bottom plate 16 can be lifted, and a plurality of wardrobes are stacked and installed.

To facilitate the movement or fixation of the wardrobe, universal wheels or non-slip pads can be fixedly installed at four corners of the bottom of the wardrobe body 1. The universal wheels are used to facilitate the movement of the wardrobe. The non-slip pads are used to prevent the movement of the wardrobe. The installation can be selected according to use needs.

Considering that the wardrobe is used in a narrow environment, the fittings at the second door frame 10 can be removed, and the wardrobe at the first door frame 9 is used only, which shortens the length of the wardrobe and improves the applicability.

The above shows and describes the basic principle, main features and advantages of the utility model. Those skilled in the art shall understand that the utility model is not limited by the above embodiments. The above embodiments and the description merely illustrate the preferred embodiments of the utility model, and are not used for limiting the utility model. Various changes and improvements can also be made to the utility model without departing from the spirit and the scope of the utility model, and these changes and improvements shall fall into the protection scope of the utility model. The protection scope of the utility model is defined by the appended claims and equivalent.

1. A folding wardrobe, comprising a wardrobe body (1) and a bottom plate (16), wherein the wardrobe body (1) comprises a first side plate (17), a second side plate (18), a third side plate (19) and a fourth side plate (20); the bottom plate (16) and the wardrobe body (1) are rotatably connected; and a first door frame (9) and a second door frame (10) are arranged in the first side plate (17);
a cover ring (8), arranged above the first side plate (17), the second side plate (18), the third side plate (19) and the fourth side plate (20);
a wardrobe body installing folding assembly, arranged in the first side plate (17) and the second side plate (18) and in the third side plate (19) and the fourth side plate (20), used for installing the entire wardrobe body (1) and capable of facilitating a user to fold the entire wardrobe body (1);
an installing assembly, arranged in the first door frame (9) and the second door frame (10) respectively and used for installing a wardrobe door (3).

2. The folding wardrobe according to claim 1, wherein the bottom of the cover ring (8) is provided with a ring bayonet (48); upper surfaces of the first side plate (17), the second side plate (18), the third side plate (19) and the fourth side plate (20) are provided with side plate grooves (26) for the ring bayonet (48) to move; an upper cover (2) is arranged above the cover ring (8); and the bottom of the upper cover (2) is fixedly connected with a hanging device (7).

3. The folding wardrobe according to claim 1, wherein the wardrobe body installing folding assembly comprises a plurality of side plate pin seats (40) arranged on both sides of the first side plate (17) and the second side plate (18); both sides of the third side plate (19) and the fourth side plate (20) are provided with a plurality of side plate bolts (41); the plurality of side plate pin seats (40) and the side plate bolts (41) are matched and installed; the third side plate (19) and the fourth side plate (20) have the same structure; and side plate bending grooves (53) are arranged in the third side plate (19) and the fourth side plate (20).

4. The folding wardrobe according to claim 1, wherein the installing assembly comprises double-head rotating shaft seats (4) arranged in the first door frame (9) and the second door frame (10) respectively; upper surfaces and lower surfaces of the double-head rotating shaft seats (4) are provided with rotating shaft columns (51); bayonet parts (50) are arranged outside the double-head rotating shaft seats (4); and inner side walls of the first door frame (9) and the second door frame (10) are provided with clamping grooves for clamping the bayonet parts (50).

5. The folding wardrobe according to claim 1, wherein the installing assembly comprises a single-head rotating shaft seat (5) arranged in the second door frame (10); a surface of the single-head rotating shaft seat (5) is provided with a rotating shaft column (51); a bayonet part (50) is arranged outside the single-head rotating shaft seat (5); and the inner side wall of the second door frame (10) is provided with a clamping groove for clamping the bayonet part (50).

6. The folding wardrobe according to claim 1, wherein a baffle plate (11), a first layer plate (13) and a second layer plate (14) are arranged in the wardrobe body (1) respectively; the first layer plate (13) is clamped between the third side plate (19) and the baffle plate (11); the second layer plate (14) is arranged between the fourth side plate (20) and the baffle plate (11); both ends of the baffle plate (11) are provided with baffle rotating shafts (35); a surface of a rear end of the first side plate (17) is symmetrically provided with side plate through holes (36); the baffle rotating shafts (35) and the side plate through holes (36) are matched and installed; a plurality of limiting blocks (42) are arranged in the second side plate (18); a plurality of layer bumps (23) are arranged outside the first layer plate (13); a baffle through hole (24) for the layer bumps (23) to move is arranged in the baffle plate (11); the bottom of the baffle through hole (24) is provided with a baffle clamping hook (12); a movable groove for the baffle clamping hook (12) to move is arranged outside the first layer plate (13); both sides of the first side plate (17) are provided with a plurality of supporting blocks (25); a plurality of side plate bumps (30) are arranged in the second side plate (18); both sides of the second side plate (18) are provided with a plurality of side plate positioning buckles (31); a plurality of layer rotating shafts (22) are arranged outside the second layer plate (14); and baffle rotating shaft seats (21) matched with the layer rotating shafts (22) are arranged outside the baffle plate (11).

7. The folding wardrobe according to claim 1, wherein the bottom of the second side plate (18) is provided with a plurality of side plate rotating shaft seats (34); the bottom plate (16) comprises a first bottom plate (161) and a second bottom plate (162); bottom rotating shafts (32) matched with the side plate rotating shaft seats (34) are arranged outside the first bottom plate (161) and the second bottom plate (162); the bottom of the first side plate (17) is provided with a plurality of inserting ports (37); and bottom inserting heads (38) matched with the inserting ports (37) are arranged outside the first bottom plate (161) and the second bottom plate (162).

8. The folding wardrobe according to claim 1, further comprising a folding drawer (6) which is movably connected with the wardrobe body (1) through a track (46), wherein both sides of the drawer (6) are hung on the track (46); both ends of the track (46) are provided with track convex buckles (43); a plurality of side plate positioning grooves (44) are arranged in the first side plate (17) and the second side plate (18); the plurality of track convex buckles (43) are clamped in the side plate positioning grooves (44); and an upper surface of the drawer (6) is provided with a track lock catch (45).

9. The folding wardrobe according to claim 1, wherein the inner wall of the first side plate (17) or the second side plate (18) is clamped with a light groove (28); the outer side of the light groove (28) is symmetrically provided with side plate clamping buckles (27); a light belt (29) is arranged in the light groove (28); and the light groove (28) is made of aluminum alloy material.

10. The folding wardrobe according to claim 1, further comprising protective sleeves (54), wherein the bottom of the wardrobe body (1) is symmetrically provided with reinforcing strips (15); a side plate installing groove (47) is arranged outside the second side plate (18); and the upper surface of the bottom plate (16) is provided with an aromatherapy box (33).
